(19) United States
(12) Patent Application Publication
(10) Pub. No.: US 2015/0106344 A1
(43) Pub. Date: Apr. 16, 2015

(54) METHODS AND SYSTEMS FOR INTELLIGENT ARCHIVE SEARCHING IN MULTIPLE REPOSITORY SYSTEMS

(71) Applicant: Calgary Scientific Inc., Calgary (CA)

(72) Inventor: Mark Allan Wagner, Calgary (CA)

(21) Appl. No.: 14/507,993

(22) Filed: Oct. 7, 2014

Related U.S. Application Data
(60) Provisional application No. 61/889,482, filed on Oct. 10, 2013.

(51) Int. Cl. G06F 17/30

(52) U.S. Cl. CPC G06F 17/30489; G06F 17/30386
USPC 707/692; 707/758

(57) ABSTRACT

Systems and methods of providing a configurable table of rules that defines a repository/archive search priority that includes multiple repositories/archives. In this manner, repository/archives are successively searched and after a first result is returned the search is stopped. Repository/archives searched in priority order based on location in pre-configured “tiers.” This enables searches to be directed to repository/archives that are best able to handle load for different types of searches, and for different types of studies as well. A duplicate priority list enables an administrator to designate which repository/archive will appear on search results list if duplicates are found. For example, in clinical study archiving systems, the search priority enables an administrator to direct searches to repository best able to handle load for different types of searches and for different types of studies.

### CROSS-REFERENCE TO RELATED APPLICATION

This application claims priority to U.S. Provisional Patent Application No. 61/889,482, filed Oct. 10, 2013, entitled “Method and Systems for Intelligent Archive Searching in Multiple Repository Systems,” which is incorporated herein by reference in its entirety.

### BACKGROUND

When a patient undergoes a study, such as an imaging study, the clinical information is stored in an electronic data repository/archive. For various reasons, the same study may be stored in more than one repository. For example, when an imaging study is sent from an imaging modality to a local picture archiving and communication system (PACS) for storage using a Digital Imaging and Communications in Medicine (DICOM) standard, it may also be pushed to a vendor neutral archive (VNA) or to an electronic medical records (EMR) system that includes a VNA. It is also possible that the study was duplicated for storage outside of the originating EMR system by way of a health information exchange (HIE) request. Typically, when queries of multiple repositories are performed to locate patient image data, each repository is searched in parallel, and all of the results are returned. This may result in inefficiencies, improper allocation of resources, and reduced performance under heavy search loads.

### SUMMARY

Disclosed herein are systems and methods for a user/administrator configurable table of rules that defines a data repository search priority in an archiving environment, for example, in clinical study archiving systems. In this manner, repositories are successively searched, and after a first result is returned the search is stopped. Repositories may be searched in priority order based on location in a hierarchy of pre-configured “tiers.” This enables an administrator to direct searches to repository best able to handle load for different types of searches, and for different types of studies as well. A duplicate priority list enables an administrator to designate which repository will appear on search results list if duplicates are found.

In accordance with aspects of the present disclosure, there is provided a method for searching multiple repositories that includes organizing the multiple repositories into a predetermined hierarchy that includes at least one tier; receiving a search request from a requester; searching the multiple repositories in accordance with the predetermined hierarchy; stopping the searching when a result to the search request is found; and communicating the result to the requester.

In accordance with aspects of the present disclosure, there is provided a method of configuring a hierarchy of repositories that includes providing a user interface, the user interface displaying a list of repositories; displaying, in the user interface, repository tiers to which the repositories are associated as defined in a configuration file; providing an edit user interface wherein an association of a repository to a tier can be changed; and reflecting changes received in the edit user interface to the configuration file as changes are received.

In accordance with other aspects of the present disclosure, there is provided a method for searching multiple repositories that includes receiving a search request from a requester; and determining if a configuration is enabled for searching the multiple repositories. If the configuration is enabled, then the method includes searching the multiple repositories in accordance with a predetermined hierarchy tiers of the multiple repositories; stopping the searching when at least one result to the search request is found within a tier of the predetermined hierarchy tiers of the multiple repositories; removing duplicate results if more than one result to the search request is found; and communicating the result to the requester.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is high level block diagram of an archiving environment 100 in which aspects of the present disclosure may be implemented;

FIG. 2 is a block diagram of tiered structure;

FIG. 3A illustrates an example operational flow in accordance with the present disclosure;

FIG. 3B illustrates another example operational flow in accordance with the present disclosure;

FIG. 4 illustrates an example listing of active database connections as selected from a Settings menu item;

FIG. 5 illustrates an example listing of tiers;

FIG. 6 illustrates an editing user interface;

FIG. 7 illustrates an example user interface for duplicate management;

FIG. 8 illustrates a detailed exemplary clinical archiving environment based on the environment of FIG. 1; and

FIG. 9 illustrates an exemplary device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While specific implementations will be described below, it will become evident to those skilled in the art that the implementations are not limited thereto.

Overview

The present disclosure is directed to a solution to provide a configurable table of rules that defines a repository search hierarchy and/or priority. When a user query is submitted, it is directed to one or more repositories, which are successively searched in a predetermined order as set by the configuration table. After a first result satisfying the query is returned from a repository/archive, the search is stopped. For example, as will become evident by the disclosure below, in a environment where medical image data is stored, a priority list may be configured having a search order of Vendor Neutral Archive (VNA) >local repository/archive (e.g., Picture Archiving and Communication Systems (PACS)) >scanner (e.g., a location of a recent stroke study that has not yet been archived). Thus, in a medical environment, the hierarchical searching structure of the present disclosure may be used for, e.g., reducing a load on resources when related studies exist on multiple repository/archives.

Example Environment

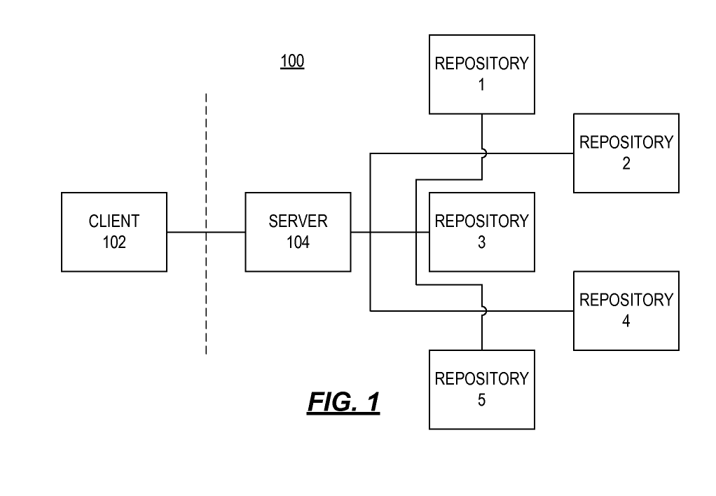

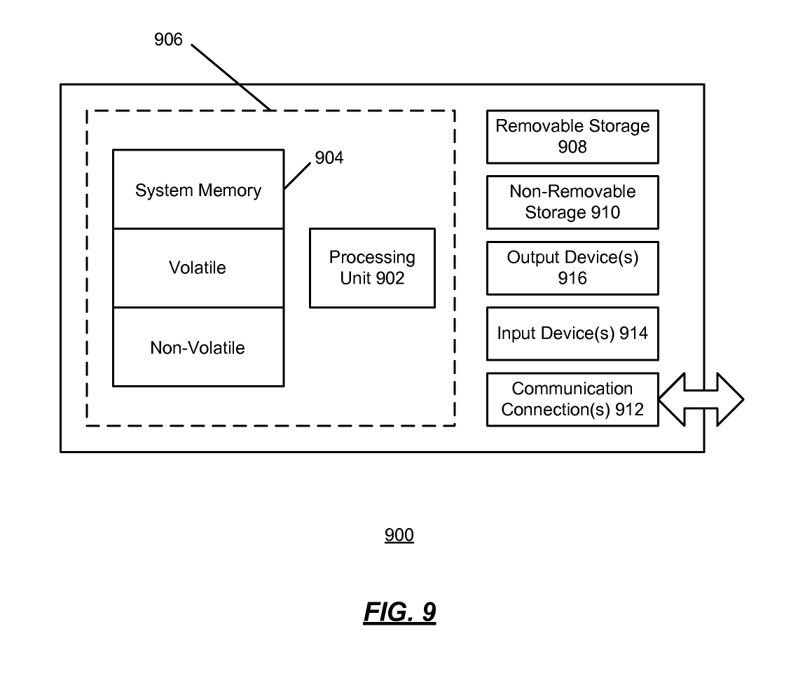

FIG. 1 is high level block diagram of an archiving environment 100 in which aspects of the present disclosure may be implemented. The environment 100 illustrates a client/server architecture, that includes at least one client 102 executing a client application, and at least one server 104 executing a database application. Although only one of each is shown in FIG. 1, there may be more than one client 102 or server 104. The server 104 may execute a database application that interacts with Repository1-Repository5 to store and retrieve data. The client 102 may execute a client application by which a user may access data from the repositories 1-5 through a keyboard, touch screen, pointing device, etc. Although not shown, the client application and the database application can be executed on the same computer. An example client 102 and server 104 are provided below with reference to FIG. 9.

In the environment 100, data may be stored in one or more of the Repository1-Repository5. To retrieve data, the client 102, using the client application, may submit a query to the database application executing on the server 104. Once received, the query is processed by the server 104 and the results are returned to the client application executing on the client 102. The client 102 may display the results or ingest the results for further processing at the client 102.

Configuration of Repository Tiers and Priorities

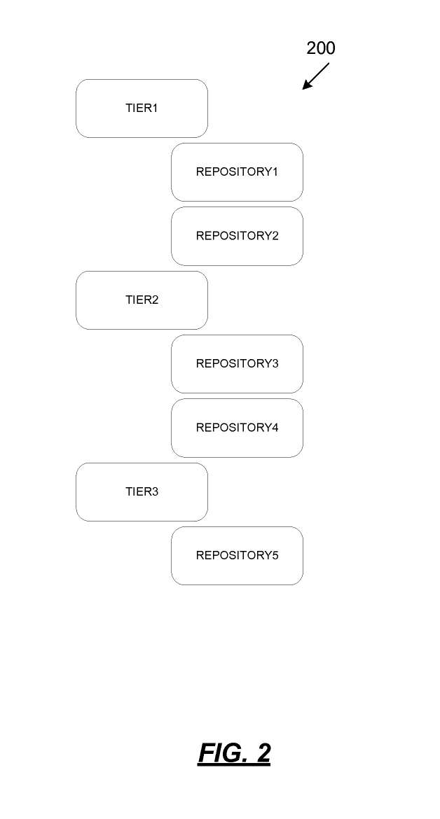

Conventionally, queries are presented to each of the repositories 1-5 in parallel. Thus, a repository is tasked to process a query even if a result is not present on the repository. To address the processing burden placed on the repository (or any other type of data storage element), and with reference to FIG. 2, the present disclosure provides for a tiered hierarchical configuration mechanism that enables an administrator, automatic tuning system, or other, to pre-configure a tiered search hierarchy and priority of repositories, such that repositories are selectively and successively searched. In this manner, repositories that likely have responsive data are the ones actually processing the queries. Further, the hierarchical configuration mechanism may operate in a manner that it is transparent to the end user.

For example, the repository tier list may be used to alleviate the load on Repository3 by directing queries to Repository2 or Repository1 if they hold data that is requested by the client 102. Thus, when a query is submitted, the hierarchical mechanism directs the processing of the query. The tiered hierarchical configuration mechanism may also be used to prioritize certain classes of users onto certain ones of the Repository1-Repository5. Still further, the tiered hierarchical configuration mechanism may be used as an access control mechanism to prevent certain client devices from accessing data within certain repositories. Yet further, the tiered hierarchical configuration mechanism may be in accordance with a location of a user, or a group to which the user belongs as determined from, e.g., a Lightweight Directory Access Protocol (LDAP) lookup. Another use may be to implement the tiered hierarchical configuration mechanism based on a type of data being requested by the user. Other uses of the tiered hierarchical configuration mechanism will become evident to those of skill in the art based on the disclosure herein.

With reference to FIG. 2, there is illustrated a block diagram of a tiered structure 200 in accordance with the present disclosure. In an implementation, the tiered structure 200 or levels (used interchangeably herein), may be defined in a configuration file using, e.g., XML format. The order of the tiers is specified by the order in which they are defined in the XML configuration file. Below is an example configuration file:

```
<RepositoryTiers>
  <RepositoryTier Name=“Tier1”>
      <Repository Name=“Repository1”/>
      <Repository Name=“Repository2”/>
  </RepositoryTier>
  <RepositoryTier Name=“Tier2”>
      <Repository Name=“Repository3”/>
      <Repository Name=“Repository4”/>
  </RepositoryTier>
  <RepositoryTier Name=“ Tier3”>
      <Repository Name=“Repository5”/>
  </RepositoryTier>
</RepositoryTiers>
```

When a query is issued, the list of repository/archives to query is intersected with the repository/archives in the first tier (Repository1 and Repository2). The resulting list of repository/archives is used in the query. If no results are found, the query is subsequently performed with the intersection with the repository/archives in the next tier (Repository3 and Repository4). This process continues until either results are found or the repository/archive tiers are exhausted, in which case no results are returned. Any repository/archive provided to query that is not listed in a tier may be put into an implicit “unassigned” tier (e.g., Repository5). This “unassigned” tier is always considered to be the last tier.

The activation and use of the tiered hierarchical configuration mechanism may be a URL-configurable option. Thus, to enable or use a repository tier list of the tiered hierarchical configuration mechanism, a parameter, e.g., UseTiers with a value of true may be specified in the URL. For example:
http://[HOSTNAME]:8080/app?client=flex&name=dataviewer&dataInstanceUID=1.2.840.113619.2.134.1762865638.1780.1100700129.716 &UseTiers=true

In accordance with some implementations, the activation of the tiered hierarchical configuration mechanism may be on-demand, such that the mechanism is used when needed. Additionally or alternatively, the configuration of the tiered hierarchical configuration mechanism may be dynamic, i.e., the configuration file may be generated and populated based on conditions within the environment 100 and/or parameters associated with the user. For example, a remote user's location may be determined, and a configuration file generating having tiers of repositories that are geographically proximate to the user.

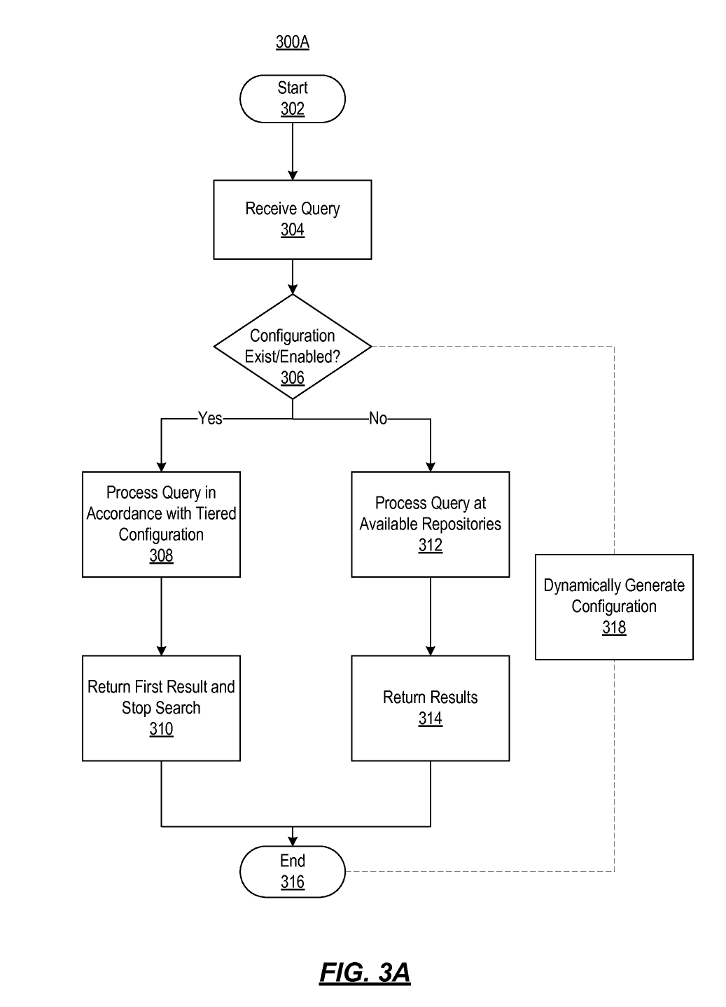

FIG. 3A illustrates an example operational flow 300A in accordance with the present disclosure. At 302, the process begins. At 304, a query is received from a requester. The query may have been submitted by the client 102 to the server 104. Next, at 306 it is determined if a configuration file exists and/or if the tiered hierarchical configuration mechanism is enabled. As noted above, a configuration file may define a tiered search hierarchy and priority of repositories, and may be provided in accordance with a global configuration, the submitting user device, a user, a user's group, a geographic location of the submitting user device, etc. The tiered hierarchical configuration mechanism may be enabled by the URL mechanism above or another activation mechanism.

If, at 306, a configuration file exists or the tiered hierarchical configuration mechanism is enabled, then at 308 the query is processed in accordance with the tiered search priority in the configuration file. In the example provided above, Repository1 and Repository2 are searched first, followed by Repository3 and Repository4, then by Repository5. At 310, in accordance with the preconfigured tiered search priority, the first result to the query is returned to the requester. Also, once the first result is found, the search is stopped, which conserves computing resources. At 316, the operational flow ends.

If, at 306, a configuration file does not exist or the tiered hierarchical configuration mechanism is not enabled, then at 312 the query is processed by each of the available repositories. At 314, the results are returned to the requester. As noted above, more than one result may be provided to the requester. At 316, the operational flow ends.

In accordance with some implementations, after the process ends at 316, a subsequent process may be performed at 318 to dynamically generate/update the configuration file. For example, environmental conditions may have changed, the user may be moving, or network latency may have increased. In some instances, the search results themselves may drive a dynamic change of the configuration file. As such, the process at 318 may update the configuration file to account for such changes.

FIG. 3B illustrates another example operational flow 300B in accordance with the present disclosure. Similar to FIG. 3A, at 302, the process begins. At 304, a query is received from a requester. The query may have been submitted by the client 102 to the server 104. Next, at 306 it is determined if a configuration file exists and/or if the tiered hierarchical configuration mechanism is enabled.

If, at 306, a configuration file exists or the tiered hierarchical configuration mechanism is enabled, a loop of the “N” configured repositories begins by setting N=1 to process the first tier at 320. In the example provided above, values of N would be one to five, where Repository1 and Repository2 are searched first, followed by Repository3 and Repository4, then by Repository5. At 322 it is determined if results are found for the repository N. If no, then N is incremented by 1 and the flow returns to 320. If results are found at 322, then at 324 any duplicate results are removed and the results are returned at 314. The process then ends at 316.

As accordance with the above, in addition to the tiered hierarchical configuration mechanism above, duplicate data may be managed using a priority list, e.g., archive-priority.xml. In some cases, the exact same data reside in multiple repositories (e.g. Repository1 and Repository3). For example, when data arrives at Repository3, it may also be pushed to the Repository1 after some delay. In order to avoid duplicate results, the repository priority list may be configured using, e.g., XML format. The order of the repositories is specified by the order in which they are defined in the XML. Below is an example archive-priority.xml file that defines a subset tier:

```
<RepositoryPriorityList>
    <Repository Name=“Repository1”/>
    <Repository Name=“Repository2”/>
    <Repository Name=“Repository3”/>
    <Repository Name=“Repository4”/>
</RepositoryPriorityList>
```

When duplicate data are returned from a query across multiple repositories, the priority list determines which duplicate to keep based on the repository priority level. If one of the duplicate data items is from a repository not listed in the priority list, it would be considered low priority and will not be displayed, however if none of the duplicates are from repositories in the priority list, all of them will be shown.

Returning again to FIG. 3B, if, at 306, a configuration file does not exist or the tiered hierarchical configuration mechanism is not enabled, then at 312 the query is processed by each of the available repositories. At 314, the results are returned to the requester. As noted above, more than one result may be provided to the requester. At 316, the operational flow ends.

In accordance with some implementations, after the process ends at 316, a subsequent process may be performed at 318 to dynamically generate/update the configuration file, as described above.

Displaying, Editing, Adding a Repository Tier List

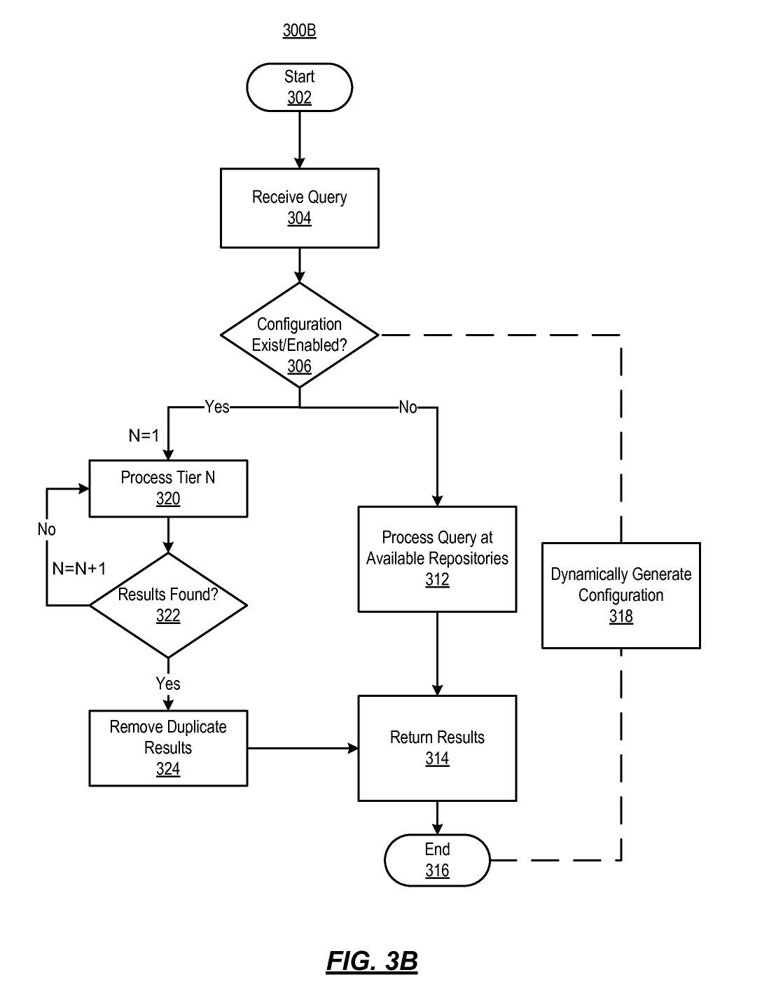

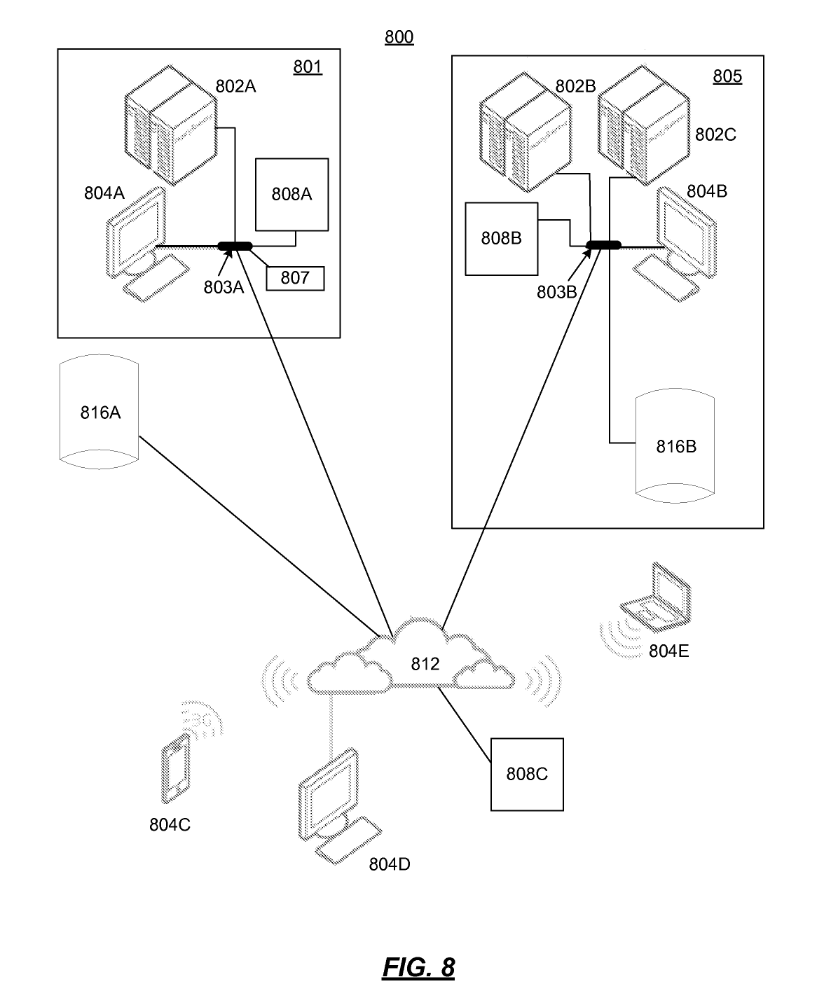

FIGS. 4-7 illustrate example user interfaces to enable user/administrator to display, edit and add repositories to the tiered list of repositories. A more detailed description of an exemplary clinical information archiving environment is described below with reference to FIG. 8.

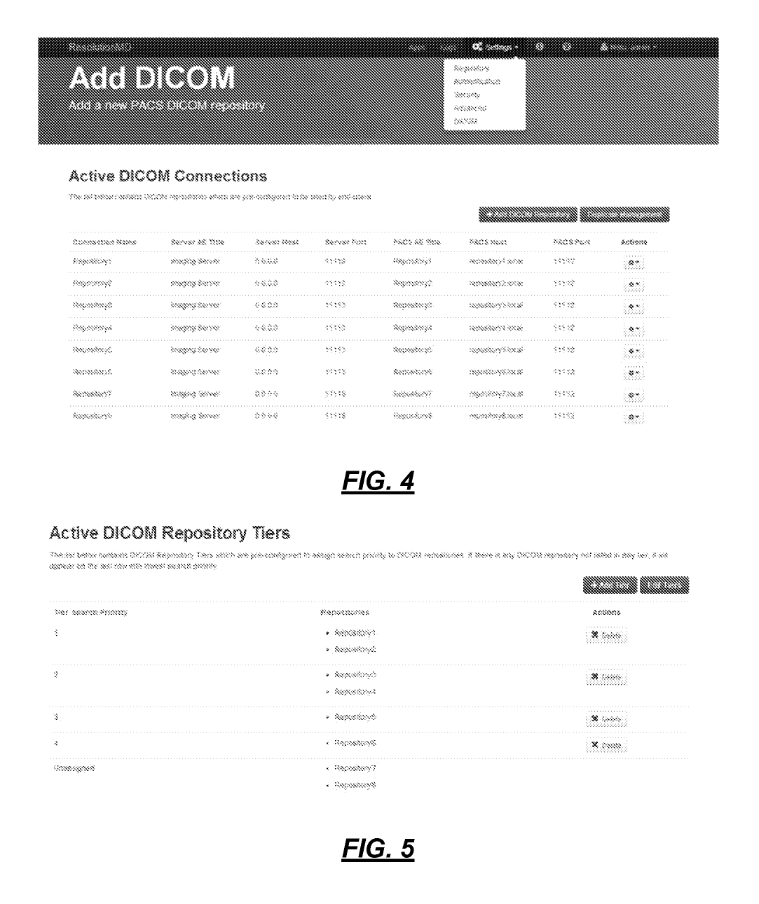

FIG. 4 illustrates a listing of active DICOM connections (selected from the Settings menu item). As shown in FIG. 4, under DICOM tab, there is listed the configured connections. As shown, there are eight available DICOM repositories configured. FIG. 5 illustrates the tiers. As shown, the available DICOM repositories have not yet been configured into tiers as they are all unassigned.

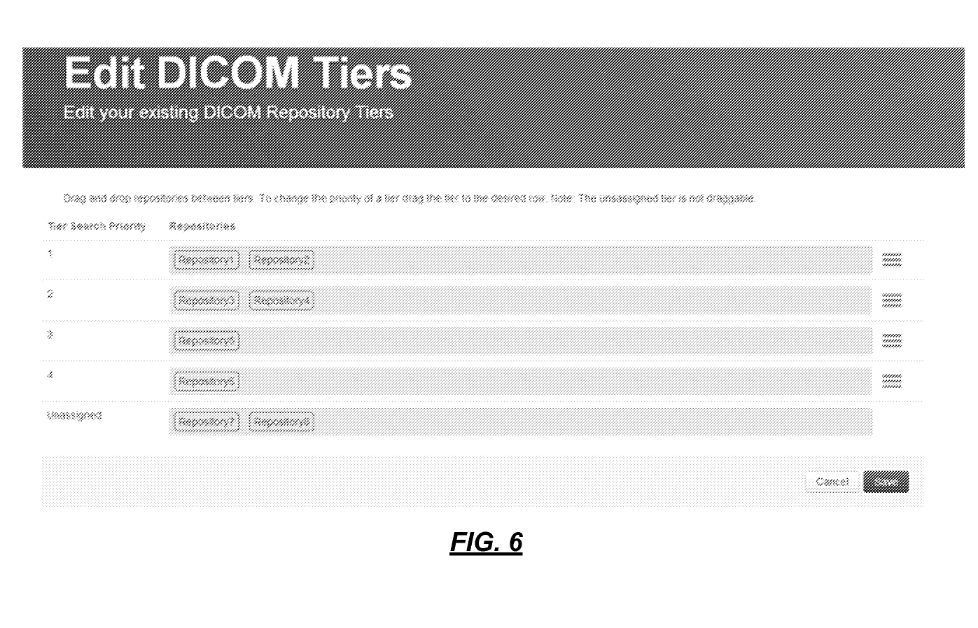

FIG. 6 illustrates an editing user interface, where the available DICOM repositories may be configured into tiers and where priorities may be set within each tier. In FIG. 6, the display shows existing tiers as read from, e.g., the archive-tiers.xml configuration file and the repositories within each tier. If there is a repository inside the configuration file that is invalid (e.g., no matching DICOM repository) it may be shown with a warning icon next to it in the tier table. If there are any unassigned repositories, each of the unassigned repositories will be shown on the last row of tier table marked as “Unassigned.” Such repositories will have the lowest search priority. If there is no tier, all DICOM repositories are grouped in the “Unassigned” tier. All tiers except the “Unassigned” one have a setting button in front of them with Edit and Delete options.

To delete one or more tiers, a button (with Edit and Delete) is provided on all the tiers except the unassigned tier. As soon as a tier is deleted it is removed from the configuration file. DICOM repository edits are propagated to the tiers such that when a DICOM repository is renamed, its respective entry in the configuration file is renamed to match the entry in tier table. Adding or deleting a repository will update the tier list accordingly. If a deletion results in an empty tier, the tier is deleted from the configuration file.

In the editing user interface, all of the repositories are draggable and all the tiers except the unassigned one are draggable. After dragging and dropping a tier, its search priority is updated. If an “add a tier” button is clicked, an empty tier is added to the end of the tier table (before unassigned tier if it exists). If there are any empty tiers when a save button is clicked, they are not added to the configuration file. If an invalid repository is dragged in to an Unassigned tier, the repository will not be written to the configuration file. Thus, editing user interface of FIG. 6 serves as a graphical editor to commit all of the above changes to the configuration file. Alternatively, the configuration file may be edited directly. As noted above, multiple configuration files may be provided in accordance with a client device location, user authentication, type of data to be accessed, etc.

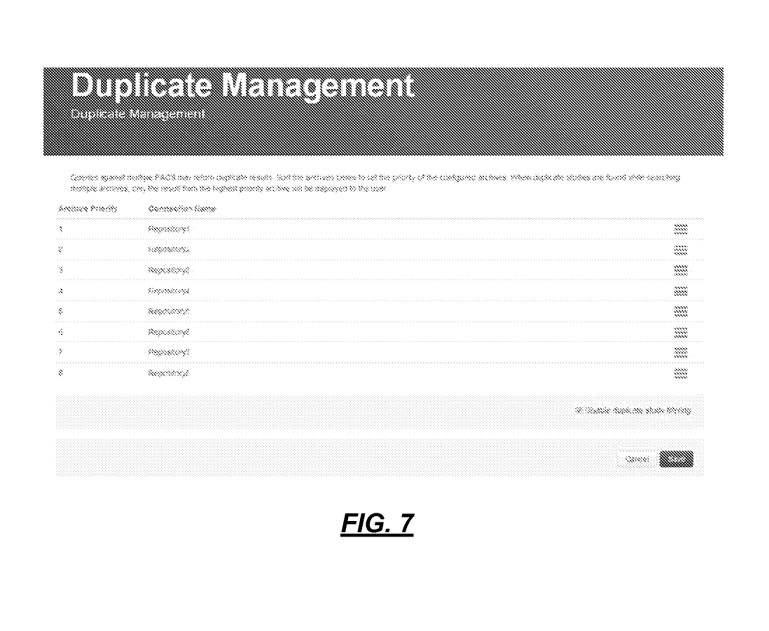

With reference to FIG. 7, the repository priority list may be added, edited, or removed. As shown in FIG. 4, there “Duplicate Management” button that brings up the interface of FIG. 7, where an administrator can drag and drop repository/archives to reorder their priorities. By clicking save button the repository priority list configuration file is updated or added if it does not exist. To erase the content of repository priority list configuration file, an administrator can check a “Disable duplicate study filtering” checkbox and click save. The checkbox's state is linked to the existence and content of the repository priority list configuration file, i.e., if the file is not present or if it has no content the checkbox will be checked when administrator navigates to the interface of FIG. 7.

Thus, in accordance with the description above, user interfaces provide an intuitive mechanism for an administrator to configure operational characteristics of the environment 100. Further, the configuration file(s) enable the administrator to implement predetermined the characteristics without requirement changes to source code. Table 1 provides a summary of the features provided in accordance with aspects of the present disclosure.

TABLE 1

| Feature | Description |
|---|---|
| Repository/archive | Administrator configurable multiple |
| Levels URL Launch | repository/archive search levels |
| | One or more repository/archives can be |
| | assigned to each level |
| | Query will be performed against first level, if no |
| | results are returned, then second level query will |
| | be initiated, etc. until searches are executed |
| | against all levels |
| | For URL launches, these repository/archive |
| | levels will only be used to manage searches if no |
| | DICOM Repository or Group is listed in the URL |
| | Launch, otherwise listed Repository or Group in |
| | URL will have priority. |
| | Note: Standalone repository/archive searching |
| | still managed/controlled by list of selected |
| | repository/archives in client |
| Managing Duplicate | Administrator configurable repository/archive |
| Returns | priority list |
| | If for any query, multiple returns of the same |
| | study are found (criteria for determining same |
| | study must include two pieces of information - |
| | Accession # and patient ID) then only the study |
| | from highest priority repository/archive will be |
| | loaded or displayed to the user |

FIG. 8 is high level exemplary clinical information archiving environment 800 in which aspects of the present disclosure may be implemented. The environment 800 of FIG. 8, includes a facility 801, which may be hospital, medical clinic, doctor's office, surgery center, etc., and an electronic medical records (EMR) system 805. The electronic medical records system 805 may provide an infrastructure to store medical and clinical data gathered in, e.g., a provider's office as electronic health records (EHRs). EHRs provide a comprehensive patient history may be retrieved in a digital format.

The facility 801 may include a Picture Archiving and Communication Systems (PACS) database 802A, a client computing device 804A, a scanner 807, and an imaging server computer 808A that are each connected to a local LAN 803A. The imaging server computer 808A may be used to connect the client computing device 804A to applications provided within the facility 801, such as a medical imaging application. The PACS database 802A may be associated with a modality, such as a sonographic scanner, a CT scanner, and an MRI scanner (shown generally as scanner 807). Typically, each modality is associated with its own PACS database.

The EMR system 805 may include PACS databases 802B and 802C, a client computing device 804B, an imaging server computer 808B, and a vendor neutral archive (VNA) 816B that are each connected to a local LAN 803B. The imaging server computer 808B may be used to connect the client computing device 804B to applications provided within the EMR 805, such as a medical imaging application. The VNA 816B is a repository that facilitates data interoperability between disparate PACS (e.g., 802B and 802C). For example, the PACS databases 802B and 802C may be provided by different vendors, which may preclude interoperability. Because the VNA 816B is vendor agnostic, it is able to communicate with each modality and respective PACS independently. Further, it is noted that the term “repository” may be used herein to refer to a PACs database, a VNA or both.

The LANs 803A and 803B may be connected to a wide area network 812, such as the Internet. In addition, other devices, such as client computing devices 804C, 804D and 804E, an imaging server computer 808C and a VNA 816A may be connected to the network 812 to provide for communication between any of the devices in the environment 800. For example, copies of the patent data may be uploaded from the PACS databases 802A-802C to the VNAs 816A-816B (e.g., with 24 hours of receipt in a respective PACS database 802A-802C) to aid in the retrieval of patent image data. The uploading of copies from the PACS databases 802A-802C to the VNAs 816A-816B may cause duplication of data, which may be managed using a priority list described above. Also, the network 812 provides for services associated with a health information exchange (HIE).

According to the present disclosure, the client computing devices 804A-804E may communicate with the PACS databases 802A, 802B, 802C, imaging server computers 808A-808C, the scanner 807, and the VNAS 816A, 816B using, e.g., a Uniform Resource Locator (URL) entered within a browser or other client interface/application.

Imaging servers 808A, 808B and 808C may be providing services to one or more “tenants” either on a Virtual Machine (VM) or as partitioned groups within the data access application (e.g., RESOLUTIONMD) on the server. Repository priorities can be specified either generally or on a per tenant basis. For example, a general priority configuration may be applied if a request is made without specifying a tenant. In other words, the priority configuration may be applied universally if it exists. Tenants may specify their own priority configuration or use the general priority configuration, or none. Further, the repository priority list is independent of the tiers described above. However, both a repository priority list and a tier configuration may be specified. In that case the priority list is only used when considering the repositories from the tier that return results.

While the facility 801 and EMR system 805 have been described as two elements in the environment 800, the facility 801 and EMR 805 could be any physical or virtual environment that includes archive and/or repository services.

In operation, the client computing devices 804A-804E may communicate with the imaging server computers 808A-808C to request and receive image data by contacting imaging server computer using an appropriate URL. The URL may pass parameters to, e.g., the imaging server computer 808B, such as a study instance ID, a repository ID, a client ID, and configuration parameters in order to retrieve data responsive to a query. The activation and use of the tiered hierarchical configuration mechanism in the environment 800 may be a URL-configurable option.

As discussed above, image data may then be retrieved from a repository in accordance with a tiered hierarchy of repositories identified in a configuration file at the imaging server computer 808B. For example, the client computing device 804B may indicate in one of the URL parameters that the query being submitted is for cardiology image data. The imaging server computer 808B may retrieve a configuration file associated with cardiology image data, which may define the following tiered hierarchy of repositories:

```
<RepositoryTiers>
  <RepositoryTier Name=“VNA”>
      <Repository Name=“VNA 816B”/>
      <Repository Name=“VNA 816A”/>
  </RepositoryTier>
  <RepositoryTier Name=“PACS”>
      <Repository Name=“PACS 802B”/>
  </RepositoryTier>
  <RepositoryTier Name=“ Unassigned”>
      <Repository Name=“PACS 802A”/>
  </RepositoryTier>
</RepositoryTiers>
```

In the above example configuration file, PACS 802C is not in the search hierarchy because, for example, the PACS 802C may not contain cardiology data. Thus, the query for cardiology data from the client computing device 804B is submitted to the first tier (“VNA”) to determine if either of the repositories VNA 816B or VNA 816A contain responsive image data. As such, the query is first submitted to VNA 816B for a response. If VNA 816B does not contain image data responsive to the client query, then VNA 816A is queried for responsive image data.

If neither VNA 816B, nor VNA 816A contain image data responsive to the client query, then the next tier (“PACS’) is searched. As such, the client query is then directed to PACS 802B. If PACs 802B does not contain image data responsive to the client query, then the Unassigned tier is searched and client query is submitted to PACs 802A. In the above, the first repository having image data responsive to client query will return such image data to the client computing device 804B and no further repositories will be searched.

From the above example, one of ordinary skill in the art would now recognized that the similar operations may be applied to each of the client computing devices 804A-804E as they contact the imaging server computers 808A-808C to submit queries for image data. Thus, it has been shown that the tiered hierarchical configuration mechanism of FIG. 1 may be implemented in the environment 800 to pre-configure a tiered search hierarchy and priority of repositories, such that repositories that likely have responsive data are the ones actually processing the queries.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

FIG. 9 shows an exemplary computing environment in which example embodiments and aspects may be implemented. The computing system environment is only one example of a suitable computing environment and is not intended to suggest any limitation as to the scope of use or functionality.

With reference to FIG. 9, an exemplary system for implementing aspects described herein includes a device, such as device 900. In its most basic configuration, device 900 typically includes at least one processing unit 902 and memory 904. Depending on the exact configuration and type of device, memory 904 may be volatile (such as random access memory (RAM)), non-volatile (such as read-only memory (ROM), flash memory, etc.), or some combination of the two. This most basic configuration is illustrated in FIG. 9 by dashed line 906.

Device 900 may have additional features/functionality. For example, device 900 may include additional storage (removable and/or non-removable) including, but not limited to, magnetic or optical disks or tape. Such additional storage is illustrated in FIG. 9 by removable storage 908 and non-removable storage 910.

Device 900 typically includes a variety of computer readable media. Computer readable media can be any available media that can be accessed by device 900 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 904, removable storage 908, and non-removable storage 910 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 900. Any such computer storage media may be part of device 900.

Device 900 may contain communications connection(s) 912 that allow the device to communicate with other devices. Device 900 may also have input device(s) 914 such as a keyboard, mouse, pen, voice input device, touch input device, etc. Output device(s) 916 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for searching multiple repositories, comprising:
organizing the multiple repositories into a predetermined hierarchy that includes at least one tier;
receiving a search request from a requester;
searching the multiple repositories in accordance with the predetermined hierarchy;
stopping the searching when a result to the search request is found; and
communicating the result to the requester.

2. The method of claim 1, wherein the predetermined hierarchy defines a plurality of tiers, wherein each of the plurality of tiers includes at least one of the multiple repositories.

3. The method of claim 2, wherein at least one tier includes at least two of the multiple repositories, and for each tier, the method further comprising:
running the search at a first identified repository of the at least two of the multiple repositories; and
if no result is found, running the search at the next identified repository of the at least two of the multiple repositories.

4. The method of claim 2, further comprising providing a default tier at a lowest priority.

5. The method of claim 1, further comprising providing the hierarchy in a configuration file.

6. The method of claim 5, further comprising reading the configuration file in accordance with a characteristic of the requester.

7. The method of claim 1, further comprising providing a graphical user interface to define the predetermined hierarchy.

8. The method of claim 7, further comprising generating a configuration file in accordance with inputs received by the graphical user interface.

9. The method of claim 1, wherein the search request is for medical image data.

10. The method of claim 1, further comprising:
determining if the result to the search request is one of duplicate results; and
removing the duplicate results prior to communicating the result to the requester.

11. A method of configuring a hierarchy of repositories, comprising:
providing a user interface, the user interface displaying a list of repositories;
displaying, in the user interface, repository tiers to which the repositories are associated as defined in a configuration file;
providing an edit user interface wherein an association of a repository to a tier can be changed; and
reflecting changes received in the edit user interface to the configuration file as changes are received.

12. The method of claim 11, further comprising providing an interface to set priorities within each of the repository tiers.

13. The method of claim 12, wherein the interface to set priorities is provided as a duplicate management user interface to reorder the list of repositories such that only one result is returned in response to a search request when duplicate results are found in the repositories.

14. The method of claim 11, further comprising identifying unassigned repositories within the list of repositories within a lowest row in the user interface.

15. The method of claim 11, wherein the configuration file is an eXtensible Markup Language file.

16. A method for searching multiple repositories, comprising:
receiving a search request from a requester; and
determining if a configuration is enabled for searching the multiple repositories, and if the configuration is enabled:
searching the multiple repositories in accordance with a predetermined hierarchy tiers of the multiple repositories;
stopping the searching when at least one result to the search request is found within a tier of the predetermined hierarchy tiers of the multiple repositories;
removing duplicate results if more than one result to the search request is found; and
communicating the result to the requester.

17. The method of claim 16, wherein the tier includes at least two of the multiple repositories, the method further comprising:
running the search at a first identified repository of the at least two of the multiple repositories; and
if no result is found, running the search at the next identified repository of the at least two of the multiple repositories.

18. The method of claim 16, if the configuration is not enabled, then the method further comprising:
searching all of the multiple repositories; and
communicating all results found to the requester.

19. The method of claim 18, further comprising enabling the configuration using a Uniform Resource Locator (URL)-configurable option.

20. The method of claim 16, further comprising setting the predetermined hierarchy tiers of the multiple repositories in accordance with a prioritization of the multiple repositories.

21. The method of claim 20, further comprising defining the prioritization to manage duplicate results.
